(19) United States
(12) Patent Application Publication
(10) Pub. No.: US 2010/0153421 A1
(43) Pub. Date: Jun. 17, 2010

(54) DEVICE AND METHOD FOR DETECTING PACKED PE FILE

(75) Inventors: Yang Seo CHOI, Daejeon (KR); Ik Kyun KIM, Daejeon (KR); Jin Tae OH, Daejeon (KR); Jae Cheol RYOU, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/434,166

(22) Filed: May 1, 2009

(30) Foreign Application Priority Data
Dec. 15, 2008 (KR) 10-2008-0127416

(51) Int. Cl. G06F 7/20; G06F 17/30

(52) U.S. Cl. 707/758; 707/E17.009

(57) ABSTRACT

The present invention discloses a device and method for detecting a packed PE (portable executable) file. In the device and method for detecting a packed PE file, information for detecting packing are extracted by analyzing the header of a target file, and a record containing characteristic values shown only in a packed PE file is created by using the extracted information. The packing of the target file is detected by calculating the similarity with a PE file which is not packed based on the created record and comparing it with a derived threshold value. Therefore, a packed PE file can be detected even if it is packed by a packing method which is not well-known.

### CROSS-REFERENCE TO RELATED APPLICATION

This application claims the benefit of Korean Application No. 2008-0127416 filed on Dec. 15, 2008 in the Korean Intellectual Property Office, the disclosure of which is incorporated by reference.

### BACKGROUND OF THE INVENTION

1. Field of the Invention

The present invention relates to a device and method for detecting a packed PE (portable executable) file, and more particularly, to a device and method for detecting a packed PE file, which can detect whether the corresponding PE file is packed or not.

The present invention is derived from research performed as a part of IT next generation engine core technology development work by the Ministry of Information and Communication and the Institute for Information Technology Advancement. [Research No.: 2006-S-042-03, Research Title Real-Time Attack Signature Generation and Management Technology Development for Dealing with Zero-Day Attacks against Network Threats]

2. Discussion of the Related Art

A method for detecting a packed PE file is divided into a method of analyzing a packing method of a PE file and a method of analyzing the structure of a PE File.

In the former case, a detection method differs according to whether the packing method is well-known or not. If the packing method is well-known, packing is detected by checking if unpacking is done by the corresponding method. If the packing method is not well-known, packing is detected by observing whether the corresponding PE file is executed and self-unpacked or not.

The latter case is a recently suggested packing detection method, which is a technique of detecting packing by analyzing the header of a PE file. Since packing is detected by extracting specific information from the header of the PE file, packing can be detected regardless of a packing method.

However, the former case makes it difficult to automate the detection of packing while the latter case may generate a wrong detection due to piecemeal detection since only specific information of the PE file is used for detecting packing.

### SUMMARY OF THE INVENTION

An object of the present invention is to provide a device and method for detecting a packed PE file, which can detect packing regardless of a packing method by analyzing the header of the PE file and determining whether a corresponding program is packed or not, and improve detection efficiency through the analysis of header information.

This object, according to the present invention, is achieved by a device for detecting a packed PE file, comprising: a header analysis unit for checking whether a target file is a PE file or not through the analysis of the header structure of the target file; a header information collection unit for creating a first record containing characteristic values shown only in the header of a packed PE file; a header information measurement unit for calculating a first similarity between the first record created in the header information collection unit and a second record created in a PE file which is not packed; and a packing detection unit for detecting packing by calculating second similarities calculated in the similarity calculation method of the header information measurement unit with respect to a plurality of packed PE files and comparing the minimum value thereof serving as a threshold value with the threshold value of the first similarity.

Additionally, this object, according to the present invention, is achieved by a method for detecting a packed PE file, comprising the steps of: checking whether a target file is a PE file or not upon receipt of the target file; extracting header information for detecting a packed PE file; creating a first record containing characteristic values shown only in the header of a packed PE file; calculating a first similarity between the first record and a second record created in a PE file which is not packed; and detecting packing by calculating second similarities calculated in the similarity calculation method of the header information measurement unit with respect to a plurality of packed PE files and comparing the minimum value thereof serving as a threshold value with the threshold value of the first similarity.

According to the present invention, the characteristics of a packed file are quantified and processed so as to detect packing. Thus, malicious file analysis and signature creation processes can be reduced because packing can be checked regardless of a packing method and a detection method can be automated.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1 is a structural view of a PE file defined by Microsoft;

FIG. 2a is a table showing the elements of IMAGE_FILE_HEADER of IMAGE_NT_HEADERS of the PE file defined by Microsoft;

FIG. 2b is a table showing the elements of standard IMAGE_OPTIONAL_HEADER of IMAGE_NT_HEADERS of the PE file defined by Microsoft;

FIG. 2c is a table showing the elements of extended IMAGE_OPTIONAL_HEADER of IMAGE_NT_HEADERS of the PE file defined by Microsoft;

FIG. 2d is a table showing the elements of IMAGE_SECTION_HEADER of the PE file defined by Microsoft;

FIG. 3 is a table of the values of the characteristics entry of IMAGE_SECTION_HEADER;

FIG. 4 is a graph showing a result of the calculation of Euclidean distance which is the similarity between a PE file which is not packed and 100 packed PE files according to one exemplary embodiment of the present invention;

FIG. 5 is a block diagram of a device for detecting a packed PE file according to one exemplary embodiment of the present invention; and

FIG. 6 is a flow chart of a method for detecting a packed PE file according to one exemplary embodiment of the present invention.

### DETAILED DESCRIPTION OF THE PREFERRED EMBODIMENTS

Hereinafter, a preferred embodiment of the present invention will be described in detail with reference to the drawings.

The present device and method for detecting a packed PE file will be described briefly below. First, header information, which has to be necessarily contained so that a packed file can make its code to be executable, is searched for in a target file. A difference in distribution between extracted header information and a pattern shown in a file which is not packed is quantified by using a similarity measurement method, such as a Euclidean distance method. Lastly, it is detected whether the target file is packed or not by comparing a value quantified from the target file with a threshold value extracted from the packed PE file.

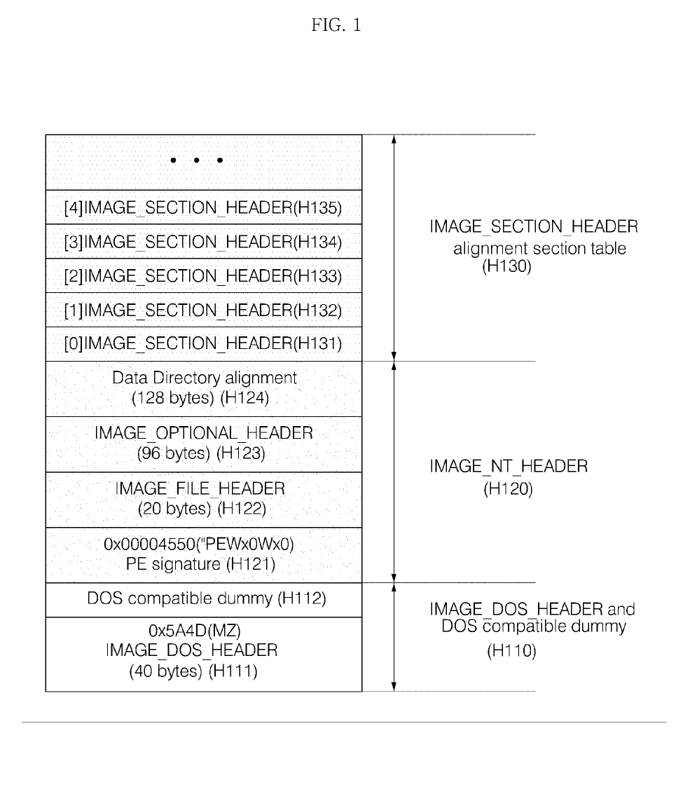

FIG. 1 is a structural view of the header of a PE file defined by Microsoft.

The PE file is an executable file which is executable in a Microsoft operating system, and contains IMAGE_DOS_HEADER, IMAGE_NT_HEADERS, and IMAGE_SECTION_HEADER. Each header contains basic information for executing a program.

IMAGE_DOS_HEADER is a part for being compatible with MS-DOS which is a previous operating system of Microsoft, in which only information about whether a target file is an executable file and offset information for moving to the starting position of IMAGE_NT_HEADER are used.

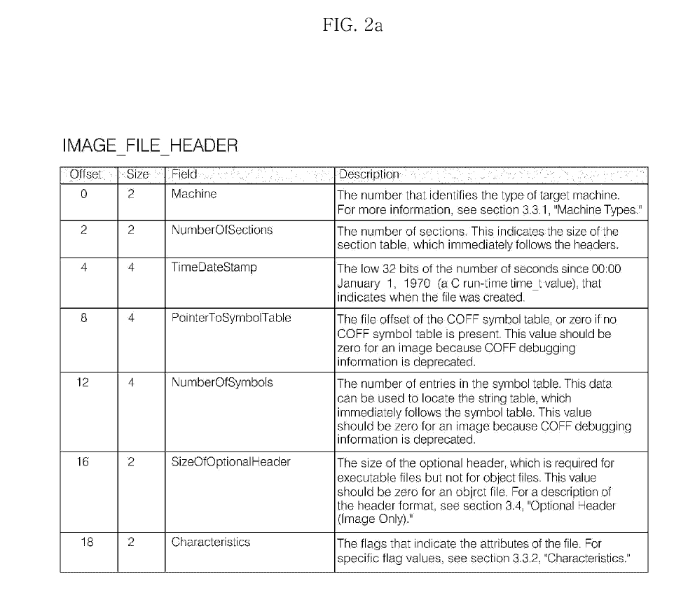

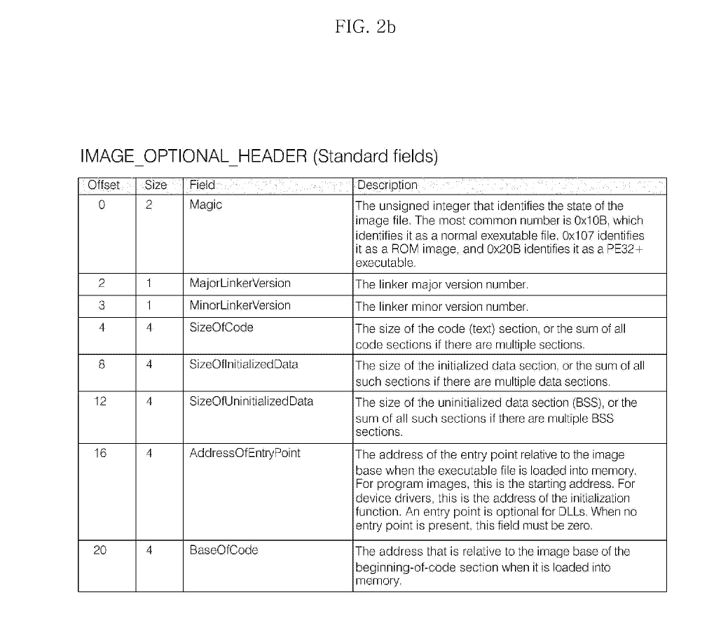

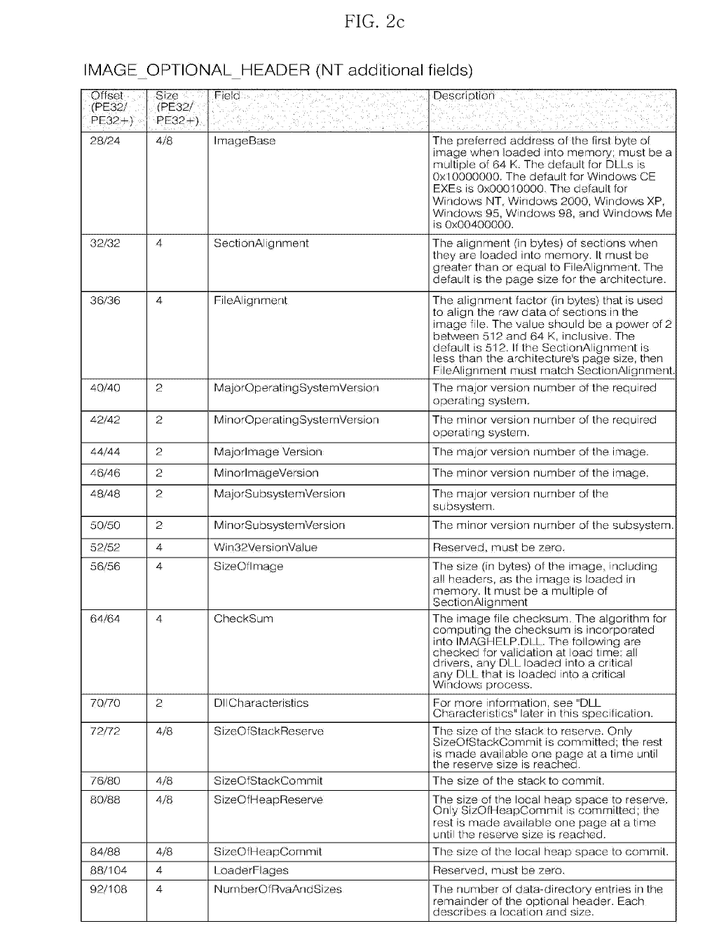

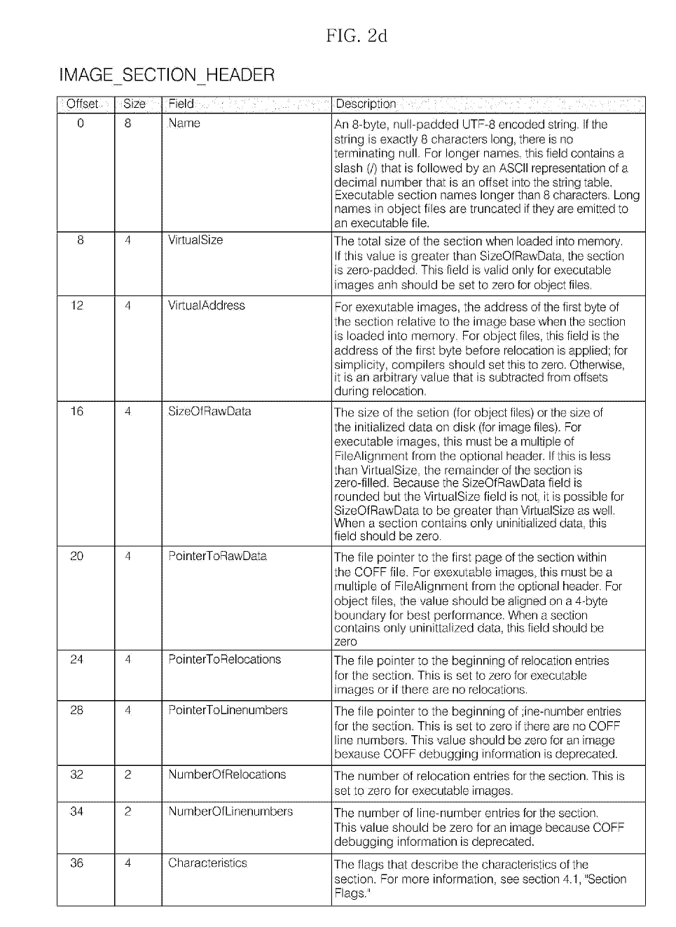

FIGS. 2a to 2d are tables showing the elements of IMAGE_NT_HEADERS and of IMAGE_SECTION_HEADER.

IMAGE_NT_HEADERS contains a PE signature which indicates that a file is a PE file, IMAGE_FILE_HEADER, and IMAGE_OPTIONAL_HEADER. IMAGE_FILE_HEADER contains the number of IMAGE_SECTION_HEADER and information representing the characteristics of a file.

IMAGE_OPTIONAL_HEADER contains information representing the position of a starting section containing the execution part of a program. In a PE file, the execution part of a program is divided by sections, and IMAGE_SECTION_HEADER manages each section.

IMAGE_SECTION_HEADER contains the starting position of each section and information representing the characteristics of each section.

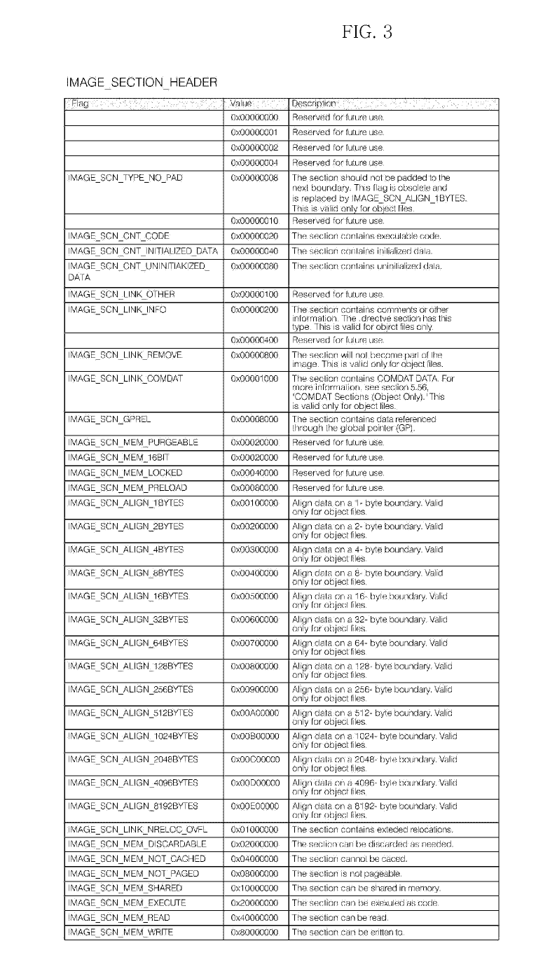

FIG. 3 is a table of the values of the Characteristics entry of IMAGE_SECTION_HEADER, which is to be used together with the entries of IMAGE_NT_HEADERS in order to detect packing in a packed PE file detecting device to be described later.

The values of the Characteristics entry of IMAGE_SECTION_HEADER include the values of IMAGE_SCN_CNT_CODE indicating that a corresponding section of a target file contains an executable code, IMAGE_SCN_MEM_WRITE indicating that a corresponding section of a target file is writable, and IMAGE_SCN_MEM_EXECUTABLE indicating that a corresponding section of a target file is executable.

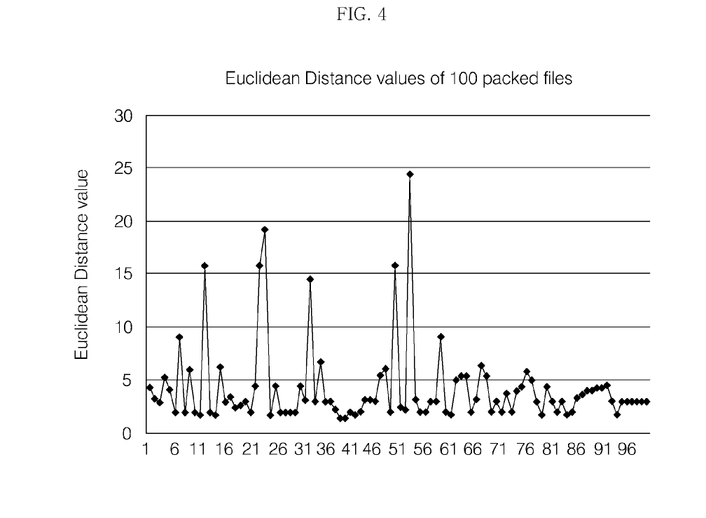

FIG. 4 is a graph showing a Euclidean distance which is the similarity between a PE file which is not packed and 100 packed PE files according to one exemplary embodiment of a threshold for detecting packing in the packed PE file detecting device to be described later. Referring to FIG. 4, it can be seen that the minimum value is 1.41. Therefore, in this embodiment, a threshold value for detecting packing is 1.41.

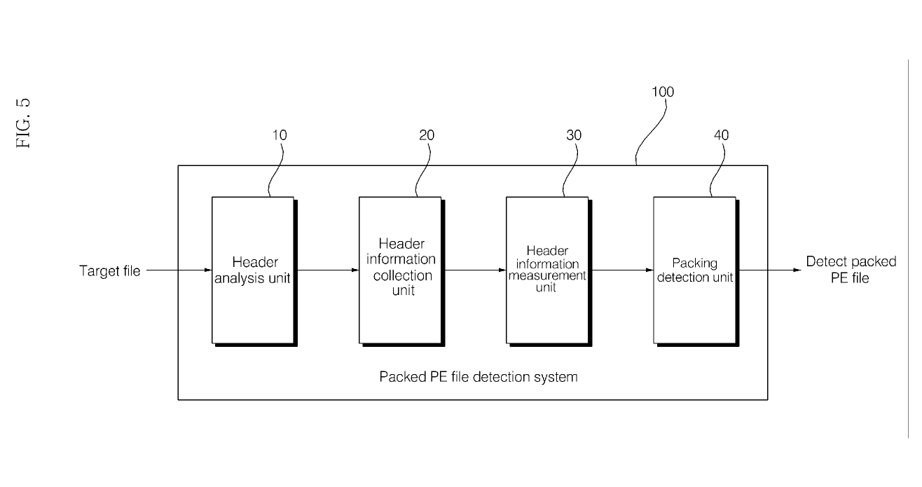

FIG. 5 is a block diagram of a device for detecting a packed PE file according to one exemplary embodiment of the present invention.

The packed PE file detecting device 100 includes a header analysis unit 10, a header information collection unit 20, a header information measurement unit 30, and a packing detection unit 40.

The header analysis unit 10 detects a PE file by structurally analyzing the header of a inputted target file.

The header analysis unit 10 checks if an executable file signature is “MZ” in IMAGE_DOS_HEADER of the PE file in order check if the header of the target file is an executable file. If the value is “MZ”, this indicates that the target file is an executable file.

In order to check if the target file is a PE file, the header analysis unit 10 reads offset information indicating the starting position of IMAGE_NT_HEADERS in IMAGE_DOS_HEADER of the PE file, moves to IMAGE_NT_HEADERS, and checks if the PE signature is “PE00”. If the value is “PE00”, this indicates that the target file is a PE file.

If the target file is a PE file, the header information collection unit 20 collects information for detecting packing. The number of or type of header information of the PE file extracted by the header information collection unit 20 in order to detect packing is changeable according to the alteration of the characteristics of packed PE files. Table 1 shows the entries extracted by the header information collection unit 20 in order to detect packing according to one exemplary embodiment of the present invention.

TABLE 1

| Entry | |
|---|---|
| No. | Description |
| Entry 1 | The number of executable and writable sections. |
| Entry 2 | The number of sections which are executable but have no code |
| | property or which have a code property but are not executable. |
| Entry 3 | The number of sections whose names are not printable. |
| Entry 4 | If there is no executable section, Entry 4 has a value of ‘1’. |
| Entry 5 | If the sum of the sizes of all sections is greater than the total file |
| | size, Entry 5 has a value of ‘1’. |
| Entry 6 | If the location of the PE signature is less than a set value, Entry |
| | 6 has a value of ‘1’. |
| Entry 7 | If the section designated by Entrypoint is not executable, Entry 7 |
| | has a value of ‘1’. |
| Entry 8 | If the section designated by Entrypoint is not a code, Entry 8 has |
| | a value of ‘1’. |

A method for collecting Entry 1 from the header information collected by the header information collection unit 20 is as follows.

The Characteristics entry of IMAGE_SECTION_HEADER may contain the values of IMAGE_SCN_MEM_EXECUTE and IMAGE_SCN_MEM_WRITE. IMAGE_SCN_MEM_EXECUTE means that the corresponding section contains the execution part of the program, and IMAGE_SCN_MEM_WRITE means that the program is able to perform a write operation on the corresponding section during execution.

In a PE file which is not packed, the values of IMAGE_SCN_MEM_EXECUTE and IMAGE_SCN_MEM_WRITE are not simultaneously shown in the same section. This is because when the execution part is changed during program execution, the program malfunctions. However, since header information is packed together upon packing, there exists a plurality of sections in which the values of IMAGE_SCN_MEM_EXECUTE and IMAGE_SCN_MEM_WRITE are simultaneously shown. Thus, the executable and writable section, such as Entry 1, is a characteristic shown only in a packed PE file, and the header information collection unit 20 detects whether a target file is packed or not by using this characteristic.

A method for collecting Entry 2 from the header information collected by the header information collection unit 20 is as follows.

The Characteristics entry of IMAGE_SECTION_HEADER may contain the values of IMAGE_SCN_CNT_CODE and IMAGE_SCN_MEM_EXECUTE. IMAGE_SCN_CNT_CODE means that the corresponding section has an executable code, and IMAGE_SCN_MEM_EXECUTE means that the corresponding section includes a program execution part.

In a PE file which is not packed, there occurs no case where the IMAGE_SCN_CNT_CODE value is not set but the IMAGE_SCN_MEM_EXECUTE value is set in the same section because this is contradictory. Similarly, there occurs no case where the IMAGE_SCN_CNT_CODE value is not set but the IMAGE_SCN_MEM_EXECUTE is set in the same section. Therefore, the section, such as entry 2, which is executable but has no code property or which has a code property but is not executable, is a characteristic shown only in a packed PE file, and the header information collection unit 20 detects whether a target file is packed or not by using this characteristic.

A method for collecting Entry 3 from the header information collected by the header information collection unit 20 is as follows.

Then Name entry of IMAGE_SECTION_HEADER stores a 8-byte section name which is encoded in UTF-8. Thus, in case of a PE file which is not packed, the Name entry of each section is printable if decoded in UTF-8, while, in case of a packed PE file, the Name entry is not printable even if decoded in UTF-8. Therefore, the header information collection unit 20 detects whether a target file is packed or not according to the printability of the Name entry.

A method for collecting Entry 4 from the header information collected by the header information collection unit 20 is as follows.

As a PE file is an executable file which is executable in a Windows operating system, at least one executable section has to exist therein. Thus, at least one of the sections has to have IMAGE_SCN_CNT_CODE set in the Characteristics entry. Therefore, if there is no IMAGE_SCN_CNT_CODE in the target file, that is, there is no executable section at all, the header information collection unit determines the target file as a packed PE file.

A method for collecting Entry 5 from the header information collected by the header information collection unit 20 is as follows.

In a PE file, the size of the program execution part is stored in bytes in the SizeOfCode entry of IMAGE_FILE_HEADER, and the size of each section is stored in bytes in the SizeOfRawData entry of IMAGE_SECTION_HEADER.

In case of a PE file which is not packed, the sum of the SizeOfRawData values of the sections having a program execution part has to be identical to the SizeOfCode value of IMAGE_FILE_HEADER. Accordingly, if the sum of the SizeOfRawData values of IMAGE_SECTION_HEADER is different from the SizeOfCode value of IMAGE_FILE_HEADER, the header information collection unit 20 determines that the target file is a packed PE file.

A method for collecting Entry 6 from the header information collected by the header information collection unit 20 is as follows.

The PE signature is located at the beginning of IMAGE_NT_HEADERS, and the header information collection unit 20 searches for the PE signature by reading offset information representing the start of IMAGE_NT_HEADERS. At this time, if the target file is packed, the location of the PE signature may be changed. If the location of the PE signature is moved, the header information collection unit 20 determines the target file as a packed PE file.

A method for collecting Entries 7 and 8 from the header information collected by the header information collection unit 20 is as follows.

The starting position of the program execution part is stored in the AddressOfEntrypoint entry of IMAGE_NT_HEADERS. In case of a packed PE file, the property of the section indicated by AddressOfEntrypoint may not be executable or not be the program execution part. In this case, the header information collection unit 20 determines the target file as a packed PE file.

The header information collection unit 20 creates a record containing information extracted for detecting whether the target file is packed or not and manages it.

The header information measurement unit 30 quantifies a difference in distribution between the record created in the header information collection unit 20 and a file which is not packed is quantified by using a similarity measurement method, such as a Euclidean distance method.

In case of a PE file which is not packed, the values of the entries of the record collected by the header information collection unit 20 all have a value of “0”. This is because the entries collected by the header information collection unit 20 are shown only in a packed PE file.

In order to obtain an Euclidean distance, each entry has to obtain a difference between the entries of the record of the target file, which is a comparison target, and the target entries of a PE file which is not packed, which is a reference target. However, the entry values of the reference target are all “0”, the Euclidean distance of the target file can be expressed by Equation 1:

ED(F)=\sqrt{Σᵢ₌₁⁸(Entryᵢ)²} [Equation 1]

wherein ED represents a Euclidean distance showing the similarity between a target file and a PE file which is not packed, F represents the target file, and Entryᵢ represents each of the entries of the record of the target file.

In another embodiment, the header information measurement unit 30 can use the Mahalanobis distance method and the K-means method for similarity measurement.

The packing detection unit 40 determines whether the target file is a packed or not by comparing the similarity quantified in the header information measurement unit 30 with a preset threshold value.

When describing by employing 1.41, which is one example of the threshold value of FIG. 4, if the similarity of the target file is less than 1.41, which is a threshold value, the packing detection unit 40 determines the target file as a PE file which is not packed.

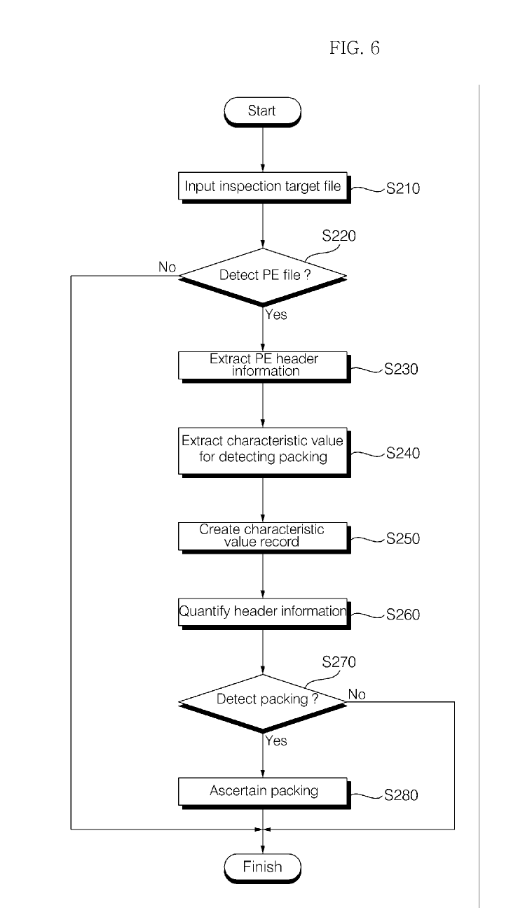

FIG. 6 is a flow chart of a method for detecting a packed PE file by the analysis of the header of the PE file.

When an inspection target file is inputted into the header analysis unit 10 (S101), it is inspected whether the target file is a PE file or not (S102). If the target file is a PE file, the header information collection unit 20 extracts header information in order to detect whether the target file is packed or not (S103), and creates characteristic values shown only in a packed file from the extracted information as a record (S105). The header information measurement unit 30 calculates the similarity between the target file and a PE file which is not packed by the Euclidean distance method (S106). The packing detection unit 40 has a threshold value of a packed PE file, and if the similarity of the target file calculated in the header information measurement unit 30 is less than the threshold value, it is determined that the target file is not a packed file (S107).

Although a specific preferred embodiment of the present invention has been illustrated and described, the present invention is not limited only to the above-described preferred embodiment, and is possible that various modifications can be made by those people skilled in the art of this invention without departing from the gist of the present invention represented by the appended claims. Such modifications are not to be regarded as a departure from the technical spirit and prospect of the invention

What is claimed is:

1. A device for detecting a packed PE file, comprising:
a header analysis unit for checking whether a target file is a PE file or not through the analysis of the header structure of the target file;
a header information collection unit for creating a first record containing characteristic values shown only in the header of a packed PE file;
a header information measurement unit for calculating a first similarity between the first record created in the header information collection unit and a second record created in a PE file which is not packed; and
a packing detection unit for detecting packing by calculating second similarities calculated in the similarity calculation method of the header information measurement unit with respect to a plurality of packed PE files and comparing the minimum value thereof serving as a threshold value with the threshold value of the first similarity.

2. The device of claim 1, wherein the first record, second record, and third record contain at least one of the entries of: the number of executable and writable sections; the number of sections which are executable but have no code property or which have a code property but are not executable; the number of sections whose names are not printable; the case there is no executable section; the case the sum of the sizes of all sections is greater than the total file size; the case the location of the PE signature is less than a set value; the case the section designated by Entrypoint is not executable; and the case the section designated by Entrypoint is not a code.

3. The device of claim 1, wherein the similarity calculation method includes one of the Euclidean distance method, the Mahalanobis distance method, and the K-means method.

4. A method for detecting a packed PE file, comprising the steps of:
checking whether a target file is a PE file or not upon receipt of the target file;
extracting header information for detecting a packed PE file;
creating a first record containing characteristic values shown only in the header of a packed PE file;
calculating a first similarity between the first record and a second record created in a PE file which is not packed; and
detecting packing by calculating second similarities calculated in the similarity calculation method of the header information measurement unit with respect to a plurality of packed PE files and comparing the minimum value thereof serving as a threshold value with the threshold value of the first similarity.

5. The method of claim 4, wherein the first record, second record, and third record contain at least one of the entries of: the number of executable and writable sections; the number of sections which are executable but have no code property or which have a code property but are not executable; the number of sections whose names are not printable; the case there is no executable section; the case the sum of the sizes of all sections is greater than the total file size; the case the location of the PE signature is less than a set value; the case the section designated by Entrypoint is not executable; and the case the section designated by Entrypoint is not a code.

6. The method of claim 4, wherein the similarity calculation method includes one of the Euclidean distance method, the Mahalanobis distance method, and the K-means method.
